(19) United States
(12) Patent Application Publication
(10) Pub. No.: US 2023/0408819 A1
(43) Pub. Date: Dec. 21, 2023

(54) NEAR-TO-EYE DISPLAY EQUIPMENT AND IMAGING METHOD THEREOF

(71) Applicant: Shenzhen Ditai Optoelectronics Co., Ltd., Shenzhen (CN)

(72) Inventors: Jianming SONG, Shenzhen (CN); Jie HU, Shenzhen (CN)

(73) Assignee: Shenzhen Ditai Optoelectronics Co., Ltd., Shenzhen (CN)

(21) Appl. No.: 17/837,623

(22) Filed: Jun. 10, 2022

(51) Int. Cl. G02B 27/01; G02B 27/12

(52) U.S. Cl. CPC G02B 27/0172; G02B 2027/011; G02B 27/126

(57) ABSTRACT

The present disclosure discloses near-to-eye display equipment and an imaging method thereof. The near-to-eye display equipment includes a group of image display screen unit used for displaying an image, a group of optical lens assembly device used for correcting various optical aberrations of optical imaging, a group of optical prism assembly device used for achieving optical distance prolonging and light path transition, a group of prism splitter device used for image beam splitting and light path transition, and a group of optical reflection device used for optical image reflection and light field compression. The entire near-to-eye display equipment of the present disclosure has a simple optical structure and easily achieves an ultra large visual-field display system. Furthermore, the structure is approximate to a coaxial design, so that the optical performance is good, and a long distance of exit pupil is more suitable for observation with human eyes.

### TECHNICAL FIELD

The present disclosure relates to the optical field, specifically to near-to-eye display equipment and an imaging method thereof.

### BACKGROUND

In recent years, with the development of microdisplays and optical software and hardware technologies, near-to-eye display products have emerged one after another, and their applications in the entertainment industry, virtual reality and other fields have become more and more extensive; the near-to-eye display equipment in the prior art often have problems of complicated optical structure, low optical performance, difficulty in achieving ultra-large visual field displaying, large image distortion in a real environment, and the like, so that a user often feels dizzy and sick, and even vomits during use.

### SUMMARY

The present disclosure provides near-to-eye display equipment capable of of solving the above technical problems, and an imaging method thereof.

In order to achieve the objective of the present disclosure, the following technical solution is adopted: One aspect of the present disclosure provides near-to-eye display equipment. The near-to-eye display equipment includes a group of image display screen unit used for displaying an image, a group of optical lens assembly device used for correcting an optical aberration of optical imaging, a group of optical prism assembly device used for achieving optical distance prolonging and light path transition, a group of prism splitter device used for image beam splitting and light path transition, and a group of optical reflection device used for optical image reflection and light field compression.

Preferably, the optical lens assembly device composed of one or more optical elements is arranged below the image display screen unit; and after the image display screen unit emits image light, the image light passes through the optical lens assembly device and enters the optical lens assembly device.

Preferably, the optical prism assembly device composed of one or more optical elements is arranged below the optical lens assembly device; and the prism splitter device composed of one or more optical elements is arranged inside the optical prism assembly device.

Preferably, the optical reflection device is arranged below the optical prism assembly device, and internal reflection or external reflection is provided in the optical reflection device.

Preferably, after optical correction processing of the optical lens assembly device, the image light becomes light suitable for observation with human eyes by reflection and focusing of the optical reflection device.

Preferably, the corrected image light after correction processing enters the optical prism assembly device to prolong an optical distance, thus obtaining extended image light.

Preferably, the extended image light becomes parallel light of an image point suitable for observation with human eyes after being reflected by the optical reflection device, and the parallel light enters the optical prism assembly device.

Preferably, when the extended image light enters the optical prism assembly device and reaches the prism splitter device, one part of the light penetrates through a prism assembly device after being reflected by the prism splitter device to become observed effective image light.

Preferably, after a user sees the observed effective image light, the user can see an amplified virtual image of the displayed image at a focal point of a reverse extension line, i.e. a virtual image light path, of the observed effective image light.

Another aspect of the present disclosure provides an imaging method of near-to-eye display equipment, using the above-mentioned near-to-eye display equipment, wherein the imaging method includes the following steps:
in step I, the image display screen unit displays a desired image; and after image light enters the optical lens assembly device, an optical aberration of optical imaging is corrected to form corrected image light;
in step II, after the corrected image light enters the optical prism assembly device, an optical distance is prolonged to form extended image light;
step III, the extended image light becomes parallel light of an image point suitable for observation with human eyes via internal reflection or external reflection of the optical reflection device, and the parallel light enters the optical prism assembly device again;
in step IV, when the extended image light reaches the prism splitter device, one part of the light penetrates through a prism assembly device after being reflected by the prism splitter device and becomes observed effective image light; and
in step V, after a user sees the observed effective image light, the user can see an amplified virtual image of the displayed image at a focal point of a reverse extension line, i.e. a virtual image light path, of the observed effective image light.

The present disclosure has the beneficial effects:

According Lu the present disclosure, the prism splitter device composed of one or more optical elements is arranged inside the optical prism assembly device; the optical lens assembly device is arranged above the optical prism assembly device, and the optical reflection device is arranged below the optical prism assembly device; the reflection effect of the optical reflection device can be both internal reflection and external reflection; after the corrected image light subjected to the correction processing by the optical lens assembly device enters the optical prism assembly device, the optical distance is prolonged, so that the image light becomes extended image light; the extended image light becomes the parallel light of the image point suitable for observation with human eyes after subjected to the internal reflection or external reflection of the optical reflection device, and the parallel light enters the optical prism assembly device again; when the extended image light reaches the prism splitter device, one part of the light penetrates through the optical prism assembly device after being reflected by the prism splitter device, and becomes observed effective image light, and after a user sees the effective image light, the user can see an amplified virtual image of the displayed image at a focal point of a reverse extension line, i.e. a virtual image light path, of the observed effective image light. The entire near-to-eye display equipment of the present disclosure has a simple optical structure and easily achieves an ultra-large visual-field display system. Furthermore, a distance between the image display screen unit and the optical lens assembly device is adjustable, which enables a visual angle to be adjustable more easily; meanwhile, image distortion of a real environment is reduced; the structure is approximate to a coaxial design, so that the optical performance is good, and a long distance of exit pupil is more suitable for observation with human eyes.

### BRIEF DESCRIPTION OF DRAWINGS

FIG. 1 is a schematic structural diagram of near-to-eye display equipment of the present disclosure;

FIG. 2 is a schematic diagram of near-to-eye display equipment of the present disclosure provided with a light path.

### DETAILED DESCRIPTION OF THE EMBODIMENTS

The embodiments of the present disclosure are described in detail below in combination with the accompanying drawings. However, the present disclosure can be implemented in various different ways defined and covered by the claims.

### Embodiment 1

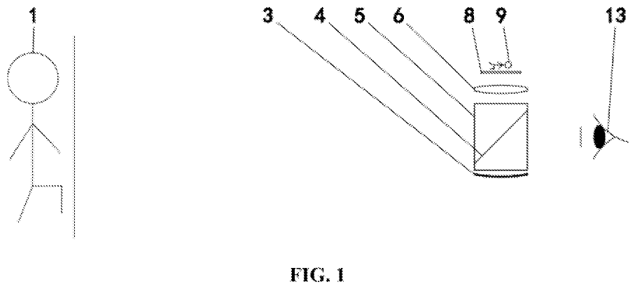

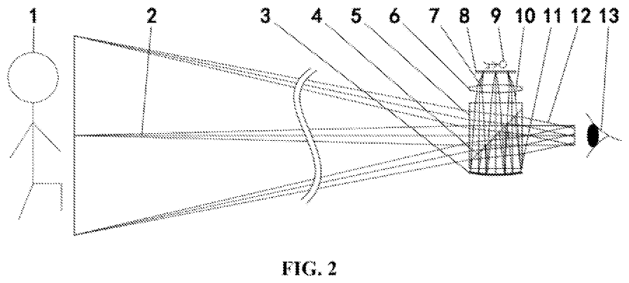

Near-to-eye display equipment, as shown in FIG. 1 and FIG. 2, includes a group of image display screen unit 8 used for displaying an image 9, a group of optical lens assembly device 6 used for correcting various optical aberrations of optical imaging, a group of optical prism assembly device 5 used for achieving optical distance prolonging and light path transition, a group of prism splitter device 4 used for image beam splitting and light path transition, and a group of optical reflection device 3 used for optical image reflection and light field compression.

Further, the image display screen unit 8 can be a common display screen on the market, and is used for displaying an image to be displayed. This belongs to the prior art, and will not be repeated here.

Further, the optical lens assembly device 6 is located below the image display screen unit 8. The optical lens assembly device 6 is composed of one or more optical elements. The optical element may be a lens. The lens may be a single lens or a cemented lens. The optical lens assembly device 6 corrects an optical aberration of image light emitted by the image display screen unit 8, so as to form corrected image light 10. The optical aberration may be a first-order aberration such as a spherical aberration, a coma aberration and a chromatic aberration, and a high-order aberration.

Further, the optical prism assembly device 5 is located below the optical lens assembly device 6. The optical prism assembly device 5 is composed of one or more optical elements. The optical prism assembly device 5 is used for prolong an optical distance for the corrected image light 10, so as to form extended image light 11. The optical prism assembly devices may be composed of two or more prisms. The optical prism assembly device 5 can spatially optically superpose and fuse the corrected image light 10 and external environment image light, so that a user can observe two superposed images at the same time. The prism is preferably a material with a high refractive index, so as to ensure a longer optical distance and enhance the observation experience.

Further, the optical reflection device 3 is used for reflecting and performing light field compression on the extended image light. The optical reflection device 3 may be internal reflection or external reflection, or may be a combination of a lens and a reflector. The optical reflection device 3 can transmit divergent light emitted by the optical prism assembly device 5 and adjust a proper light field. Light emitted by a single image pixel is adjusted to virtual object light corresponding to the oxyoptex of human eyes, so as to enable a user to observe the displayed image. When the optical reflection device 3 is formed by combining a reflector and a lens, the optical reflection device 3 can control the imaging quality of the system, and can also control the magnifying power of a visual angle optically observed by the system.

Further, the prism splitter device 4 is used for transitioning and splitting the reflected light; and the split light is observed by a user after passing through the optical prism assembly device 5, so that the user can see an amplified virtual image 1 of the displayed image 9 at a focal point of a reverse extension line, i.e. a virtual image light path, of the light.

### Embodiment 2

An imaging method of the near-to-eye display equipment includes the following steps:
in step I, the image display screen unit 8 displays a desired image 9; and after image light enters the optical lens assembly device 6, an optical aberration of optical imaging is corrected to form corrected image light 10;
in step II, after the corrected image light 10 enters the optical prism assembly device 5, an optical distance is prolonged to form extended image light 11;
step III, the extended image light 11 becomes parallel light of an image point suitable for observation with human eyes via internal reflection or external reflection of the optical reflection device 3, and the parallel light enters the optical prism assembly device 5 again;
in step IV, when the extended image light 11 reaches the prism splitter device 4, one part of the light penetrates through a prism assembly device 5 after being reflected by the prism splitter device 4 and becomes observed effective image light 12; and
in step V, after a user sees the observed effective image light 12, the user can see an amplified virtual image 1 of the displayed image 9 at a focal point of a reverse extension line, i.e. a virtual image light path, of the observed effective image light 12.

The entire near-to-eye display equipment of the present disclosure has a simple optical structure and easily achieves an ultra-large visual-field display system. Furthermore, a distance between the image display screen unit and the optical lens assembly device is adjustable, which enables a visual angle to be adjustable more easily; meanwhile, image distortion of a real environment is reduced; the structure is approximate to a coaxial design, so that the optical performance is good, and a long distance of exit pupil is more suitable for observation with human eyes.

### Specific Embodiments

One specific embodiment of the present disclosure is described below. In this embodiment, an imaging method of the near-to-eye display equipment includes the following steps:
in step I, an image 9 to be displayed is displayed on the image display screen unit 8 the optical lens assembly device 6 is arranged below the image display screen unit 8; image light 7 is emitted from the image display screen unit 8, passes through the optical lens assembly device 6 composed of one or more optical elements, and enters the optical prism assembly device 5 composed of one or more optical elements;
in step II, the prism splitter device 4 composed of one or more optical elements is arranged inside the optical prism assembly device 5; the optical reflection device 3 is arranged below the optical prism assembly device 5, the image light 7 becomes light suitable for observation with human eyes under the internal reflection or external reflection of the optical reflection device 3;
in step III, the corrected image light 10 after correction processing enters the optical prism assembly device 5 to prolong an optical distance, thus obtaining extended image light 11;
in step IV, the extended image light 11 becomes parallel light of an image point suitable for observation with human eyes via the internal reflection or external reflection of the optical reflection device 3, and the parallel light enters the optical prism assembly device 5 again;
in step V, when the extended image light enters the optical prism assembly device 5 again and reaches the prism splitter device 4, one part of the light penetrates through the optical prism assembly device 5 after being reflected by the prism splitter device 4 and becomes observed effective image light 12; and
in step VI, after a user sees the observed effective image light 12, the user can see an amplified virtual image 1 of the displayed image 9 at a focal point of a reverse extension line, i.e. a virtual image light path, of the observed effective image light 12.

The above descriptions are only specific implementations of the present disclosure, but the protection scope of the present disclosure is not limited thereto. Any changes or substitutions without creative work should fall within the protection scope of the present disclosure. Therefore, the protection scope of the present disclosure shall be subject to the protection scope of the claims.

What is claimed is:

1. Near-to-eye display equipment, wherein the near-to-eye display equipment comprises a group of image display screen unit used for displaying an image, a group of optical lens assembly device used for correcting an optical aberration of optical imaging, a group of optical prism assembly device used for achieving optical distance prolonging and light path transition, a group of prism splitter device used for image beam splitting and light path transition, and a group of optical reflection device used for optical image reflection and light field compression.

2. The near-to-eye display equipment according to claim 1, wherein the optical lens assembly device composed of one or more optical elements is arranged below the image display screen unit; and after the image display screen unit emits image light, the image light passes through the optical lens assembly device and enters the optical lens assembly device.

3. The near-to-eye display equipment according to claim 1, wherein the optical prism assembly device composed of one or more optical elements is arranged below the optical lens assembly device; and the prism splitter device composed of one or more optical elements is arranged inside the optical prism assembly device.

4. The near-to-eye display equipment according to claim 1, wherein the optical reflection device is arranged below the optical prism assembly device, and internal reflection or external reflection is provided in the optical reflection device.

5. The near-to-eye display equipment according to claim 2, wherein after optical correction processing of the optical lens assembly device, the image light becomes light suitable for observation with human eyes by reflection and focusing of the optical reflection device.

6. The near-to-eye display equipment according to claim 5, wherein the corrected image light after correction processing enters the optical prism assembly device to prolong an optical distance, thus obtaining extended image light.

7. The near-to-eye display equipment according to claim 6, wherein the extended image light becomes parallel light of an image point suitable for observation with human eyes after being reflected by the optical reflection device, and the parallel light enters the optical prism assembly device.

8. The near-to-eye display equipment according to claim 7, wherein when the extended image light enters the optical prism assembly device and reaches the prism splitter device, one part of the light penetrates through a prism assembly device after being reflected by the prism splitter device to become observed effective image light.

9. The near-to-eye display equipment according to claim 8, wherein after a user sees the observed effective image light, the user can see an amplified virtual image of the displayed image at a local point of a reverse extension line, i.e. a virtual image light path, of the observed effective image light.

10. An imaging method of near-to-eye display equipment, using the near-to-eye display equipment according to claim 1, wherein the imaging method comprises the following steps:
in step I, the image display screen unit displays a desired image; and after image light enters the optical lens assembly device, an optical aberration of optical imaging is corrected to form corrected image light;
in step II, after the corrected image light enters the optical prism assembly device, an optical distance is prolonged to form extended image light;
in step III, the extended image light becomes parallel light of an image point suitable for observation with human eyes via internal reflection or external reflection of the optical reflection device, and the parallel light enters the optical prism assembly device again;
in step IV, when the extended image light reaches the prism splitter device, one part of the light penetrates through a prism assembly device after being reflected by the prism splitter device and becomes observed effective image light; and
in step V, after a user sees the observed effective image light, the user can see an amplified virtual image of the displayed image at a focal point of a reverse extension line, i.e. a virtual image light path, of the observed effective image light.
